(19) United States
(12) Patent Application Publication
(10) Pub. No.: US 2007/0124700 A1
(43) Pub. Date: May 31, 2007

(54) Method of generating icons for content items

(75) Inventors: Ari M. Koivisto, Tampere (FI); Tero Jokela, Tampere (FI); Timo T. Koskinen, Toijala (FI); Andrei Popescu, Helsinki (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/288,768

(22) Filed: Nov. 29, 2005

(51) Int. Cl. G06F 17/00

(52) U.S. Cl. 715/837

(57) ABSTRACT

The present invention relates to a method for creating icons for graphical user interface in an electronic device. The electronic device comprises an icon generation module configured to: analyse at least some contents of a content item, select a portion of the content item on the basis of an algorithm, and specify an icon from the selected content item portion.

### FIELD OF THE INVENTION

The invention relates to a method for generating icons for content items, to an electronic device, and to a computer program product.

### DESCRIPTION OF THE RELATED ART

Computing devices include a number of applications for various purposes. Many of these applications are for processing content items, such as document files, image files or presentation files. Typically, an operating system of an electronic device provides a specific file management view in which different content items and their storage locations in a folder structure are identified. Since a user may have a large number of content items in his electronic device, for instance a large number of images or presentations, there should be more descriptive identification methods besides file names. A common feature of operating systems is that a file type specific icon identifies the file type of a file.

A solution is known for extracting icons from various types of files. IconCool-shareware (www.iconcool.net) enables a user to extract icons in PC environment. Another icon creation solution has been suggested in which a context of a file is first established by parsing its name, location and text. Frequent terms and noun phrases found in the text are used to generate a query to an image database. An icon is created from an image from the database. A drawback in this solution is that a large database may be needed in order to have appropriate images for various contexts. An image selected on the basis of a frequently occurring word may also be misleading.

### SUMMARY OF THE INVENTION

There is now provided an enhanced solution for icon creation in an electronic device. This solution may be achieved by a method, an electronic device, a computer program product, and an arrangement, which are characterized by what is disclosed in the independent claims. Some embodiments of the invention are set forth in the dependent claims.

According to an aspect of the invention, an icon generation module has been developed for an electronic device, the module being configured to: analyse at least some contents of a content item, select a portion of the content item on the basis of an algorithm, and specify an icon from the selected content item portion.

The term “icon” is to be understood broadly and refers to any kind of displayable representation of a content item. The term “content item” is to be understood broadly and it may refer to a data item comprising multiple or single media components or types, to a complete presentation, or even to a data entity in a multimedia file, for instance. The specification of an icon is to be understood to cover one or more icon definition or generation functions, and may involve storing of the selected content item portion and associating the content item portion to the content item, for instance.

According to an embodiment of the invention, the electronic device is configured to determine if there is a portion of a given media type in the content item. The electronic device is further configured to select for the icon a portion comprising data of the given media type.

According to another embodiment of the invention, the electronic device is configured to check if there is a portion in the content item meeting a primary criterion. The electronic device is configured to check if any other objects meeting a given secondary criterion exist if there is no appropriate content item portion meeting the primary criterion. The electronic device is then configured to form the icon from one or more objects meeting the given secondary criterion.

The embodiments of the invention provide several advantages. An improved visualisation in icons is possible on the basis of file contents. This is especially useful when searching for a specific content item amongst a large number of content items, for instance when searching for a specific presentation file in a file folder. Specific portions of content items may be searched from the content item. An icon generated from a specific portion of the content item, such as an image, enables to generate better descriptive icons as compared to earlier solutions. Further, the generation of the content-based icons may be automatic and no specific image database is required for icon generation.

### BRIEF DESCRIPTION OF THE DRAWINGS

In the following, the invention will be described in greater detail with reference to exemplary embodiments and the accompanying drawings, in which

FIG. 1 shows an example of an electronic device;

FIG. 2 illustrates modules of the electronic device in accordance with an embodiment of the invention;

FIG. 3 illustrates a method in accordance with an embodiment of the invention; and

FIGS. 4a and 4b illustrate page content processing according to an embodiment of the invention.

### DETAILED DESCRIPTION OF EMBODIMENTS

The embodiments of the invention are applicable to a wide variety of electronic devices with graphical user interfaces. For instance, the present electronic device may be a mobile station used as a terminal in telecommunication systems comprising one or more base stations. The device could be used for short-range communication, such as one implemented with a Bluetooth chip, an infrared or a WLAN connection. The portable electronic device could be a PDA (Personal Digital Assistant) device including the necessary telecommunication means for establishing a network connection, or a PDA device that can be coupled to a mobile telephone, for instance, for a network connection. However, the present features could be implemented in a laptop or desktop computer, an accessory device, or a computing device including no telecommunication means. To name some further examples, the electronic device could be a browsing device or a digital entertainment device, such as a personal or a domestic media player device or a game console.

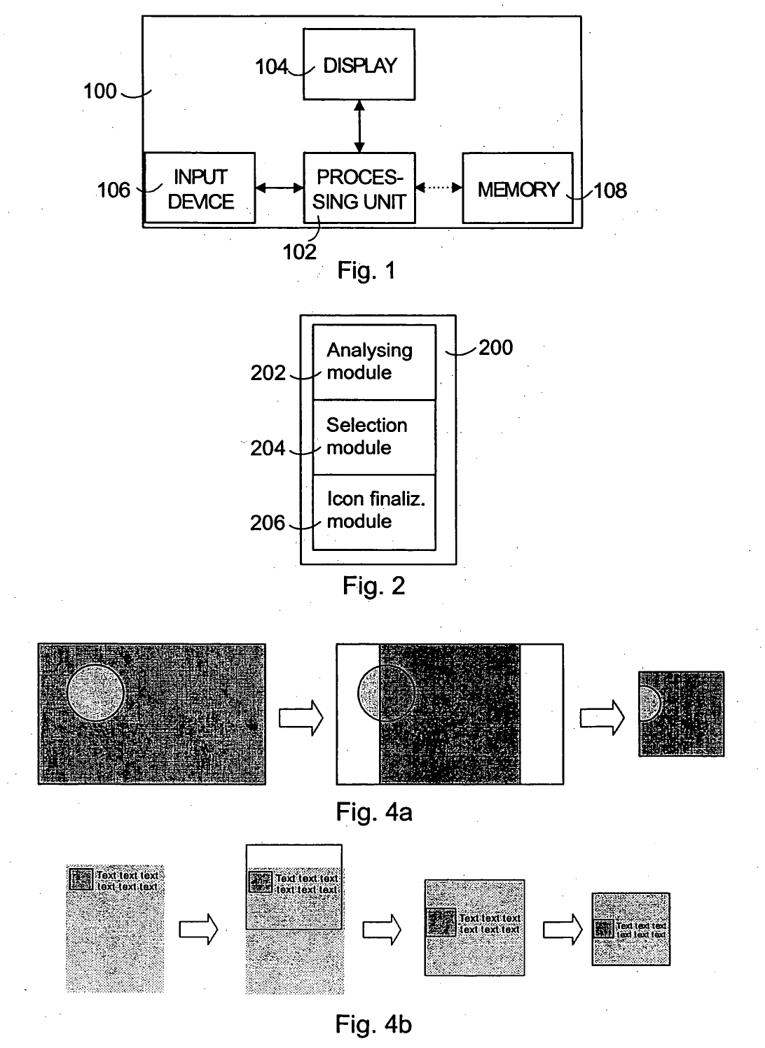

FIG. 1 shows a simplified block diagram of the structure of an electronic device 100. A control unit or a processing unit 102 controls at least some functions of the device 100 and is connected to memory 108. A user interface of the device comprises an input device 106, for instance a keypad, and a display 104. In addition, the user interface of the device may include other parts, such as a microphone, and a loudspeaker. Depending on the type of the device, there may be different and a different number of user interface components. The device 100 may also comprise communication module(s), for instance a transceiver for communicating with a base station of a mobile communications system, and speech and channel coders, modulators and RF parts.

Inputs from the user of the electronic device are received by means of the input device 106. The processing unit 102 is connected to the display 104 and configured to control different application views on the display 102. The processing unit 102 receives user input commands from the input device 106. The input device 106 receives user inputs for selecting available options in application specific views, such as a file folder view showing available content item files and associated icons, and for navigating in different operating modes of the electronic device. The processing unit 102 interprets the detected selections to the user input device 106, performs given software functions based thereon and, as a result of the performed software functions, defines and displays an updated view on the display 104, including an icon associated with a content item, for instance.

The processing unit 102 comprises one or more processors. One embodiment of the electronic device 100 is a computer program product to generate icons for content items. Computer program codes executed in the processing unit 102 may be used for causing the electronic device 100 to implement means for providing inventive functions relating to generating content specific icons, some embodiments of the inventive functions being illustrated below in association with the following figures. The computer program product may be embodied on a distribution medium. The distribution medium may be any means for distributing software to customers, such as a (computer readable) program storage medium, a (computer readable) memory, a (computer readable) software distribution package, a (computer readable) signal, or a (computer readable) telecommunications signal.

In principle, hardware solutions or a combination of hardware and software solutions may also be used to implement the inventive functions in the electronic device 100. For instance, one or more integrated circuits, such as application-specific integrated circuits ASIC, may be used.

A chip unit or some other kind of hardware module for controlling the electronic device 100 may, in one embodiment, cause the device to perform the inventive functions. Such a hardware module comprises connecting means for connection to the electronic device 100 mechanically and/or functionally. Thus, the hardware module may form part of the device and could be removable. Some examples of such a hardware module are a sub-assembly, a portable data storage medium, an IC card, or an accessory device.

FIG. 2 illustrates specific modules to be applied in the electronic device 100. The electronic device 100 includes, in addition to normal hardware and software of an electronic device, an icon generation module 200 to generate content item specific icons from a portion of the content items on the basis of one or more algorithms, i.e. the icon is specified from a portion of a content item selected on the basis of one or more predetermined rule(s) or criterion (criteria). Icons may be created from content items of a single media type or multiple media types.

In a further embodiment illustrated in FIG. 2, the icon generation module 200 comprises the following modules: an analysing module 202 to analyse contents of a content item from which an icon is to be created, a content item portion selection module 204 to select a portion of the content item on the basis of a predetermined algorithm, and an icon finalization module 206 to establish and store an icon from the selected portion of the content item. It is to be noted that the modules 202 and 204 may implement the predetermined algorithm for selecting the content item portion: The analysing module 202 may be configured to search for a predetermined part of the content item and the selection module 204 may be configured to select an available portion, if appropriate. It is to be noted that the term “algorithm” is to be understood broadly to refer to means, such as specific computer program codes and related settings, causing the desired functions related to the selection of the content item portion. In one embodiment, the user may modify some aspects affecting the selection function, whereby the icon generation may be adapted according to user preferences. The modules in FIG. 2 also represent method steps: The present method of generating content specific icons involves first the features provided by module 202, then the features of the module 204, and finally the finalization of the icon.

The modules in FIG. 2 may be implemented by the processing unit 102, by executing computer program codes from the memory 108 in the processing unit of the electronic device 100. It should be appreciated that the blocks illustrated in FIG. 2 are only illustrative and can be implemented in a variety of different circuit configurations. In one embodiment, the modules may be distributed among a plurality of units. The modules and further features illustrated below may be implemented as a program modification to application software, operating system software, and/or as a separate program controlling the operation of the processing unit 102.

In one embodiment, the icon generation module 200 is configured to search for and select a specific content type in the content item. Hence the analysing module 202 may be configured to search for specific file types included in the content item. In one further embodiment, the icon generation module 200 is configured to determine if an image exists in the content item, and select an image for icon specification as a response to the content item comprising an image. For instance, the icon generation module 200 may be configured to search for any JPEG files included in the content item.

In one embodiment, the icon generation module 200, or an application in or for which the content item module 200 is applied, first opens the content item. For instance, a presentation is first opened or created in a presentation editor, and then the contents of the presentation are analysed. Hence, the icon may be created from a content item being viewed or edited.

In one embodiment, the icon generation module 200 is implemented as part of a presentation editor application. An icon may be associated with a content item in various ways. In one embodiment, the icon is part of the content item itself. The icon may be stored in a separate file. The icon generation may be initiated by user input or automatically. The icon may be generated for a presentation when editing or finalizing the presentation and the present icon generation features may be implemented by an authoring tool. This embodiment enables to utilize information available at the presentation edit time for icon generation and also an easy implementation of content item analysing and portion selection.

In one embodiment, the icon generation is performed in connection with storing the content item as a file. For instance, when an input for closing the content item or for storing the content item is detected from the user, the electronic device 100 is arranged to initiate an icon generation process by the icon generation module 200.

In another embodiment, the icon generation features are not application specific but part of an underlying operating system or a higher level software component, such as a desktop manager. Icons may be generated by system specific functions for various types of content items. However, certain application or content item specific features may be used for icon generation, in particular for analysing content items and selecting suitable portions for icons. A plug-in owned by the operating system or the desktop manager may provide present icon generation features. The icons may be stored in a general-purpose repository.

One criterion that may be applied when selecting an appropriate content item portion is the size of an available content item. Thus, the icon generation module 200 may be configured to select an available content item portion if it is large enough. For instance, the analysing module 202 may be configured to determine the size of an available content item portion. In an embodiment, the icon generation module 200, in the embodiment of FIG. 2 the selection module 204, is configured to compare the size of an available content item portion to a predetermined minimum size required for the icon. The icon generation module 200 is configured to select the content item portion for icon generation if the size of the content item portion exceeds the predetermined minimum size and hence covers a predetermined portion of the available icon area. It is to be noted that one or more applicable icon sizes may be determined in the icon generation module 200, and a predetermined deviation from the icon size may be allowed. For instance, the icon generation module 200 may be configured to select a content item portion if its size is at least 70% of the predetermined icon size. The selection module 204 may be configured to compare the size of the available content item portion to a predetermined minimum size setting, and select the available content item portion if it exceeds or is at least equal to the predetermined minimum size setting.

The algorithm may involve a plurality of checking rules or steps for selecting an appropriate content item portion. In one embodiment, the icon generation module 200 is first configured to check if there is a portion in the content item (or at least in the examined part of the content item) meeting a primary criterion. If not, the icon generation module 200 is configured to check if any other content item portions meeting a predetermined secondary criterion exist. If a content item meeting the secondary criterion is found, the icon generation module 200 is configured to form the icon from one or more objects meeting the predetermined secondary criterion. In one embodiment, on the basis of the secondary criterion, the icon generation module 200 is arranged to search for a second type of content portions. There are many available objects that may be searched for and used as a secondary basis for the icon. For instance, the icon generation module 200 may be arranged to search a text with a specific property or a keyword.

The content item may be a presentation or a document comprising multiple pages or other portions that are separate from each other. In one embodiment, the icon generation module 200 is configured to analyse a content item with one such portion or page at a time. Thus, a second page following a first page may be analysed if, on the basis of the analysing of the first page, the contents of the first page do not comprise a portion meeting the at least one predetermined selection criterion to be selected for icon creation. It is to be noted that the analysing does not have to start from the first page of the presentation or the document and pages may also be omitted.

The icon generation module 200 may be configured to search the contents of a page being analysed for object(s) meeting predetermined criterion for icon generation. In one embodiment, a page comprising an appropriate object, for instance an image large enough, is as a whole used for creating an icon. In an alternative embodiment, an icon is generated using only a portion of such a page. In a further embodiment, the icon generation module 200 is configured to generate an icon by using only an object appropriate for icon generation and discarding other page contents.

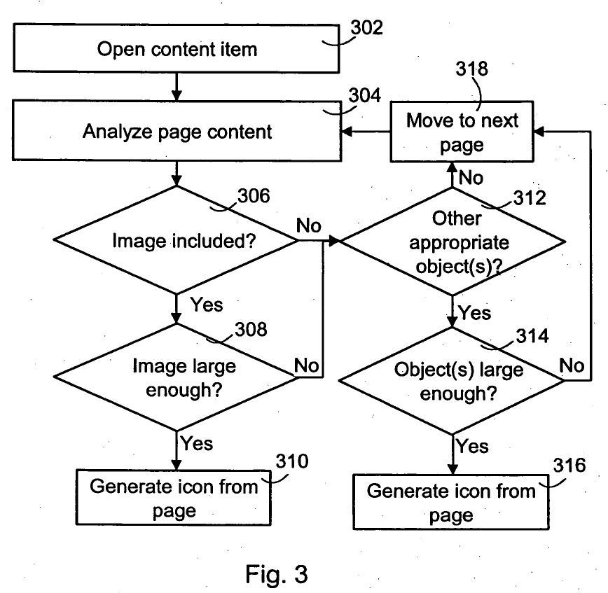

FIG. 3 illustrates a method for icon generation applying the above illustrated features. In the present embodiment, the icon generation is applied in or by an application capable of opening a content item from which an icon is to be generated, either based on user initiation or automatically. In step 302 the content item is opened. A page (e.g. starting from the first one) at a time is analysed 304 and first checked 306 for any type of image objects. If an image is available, the size of the image is checked 308. If the image is large enough, step 310 may be entered and an icon be specified from this page. In an alternative embodiment, the icon is generated from the image detected as appropriate for the icon. Thus the image file may be cropped from the content item and stored in the memory 108 such that it is associated with the file. In another embodiment, a reference to the image is obtained from the content item and the icon is generated based on the reference. The image may be modified before storing it as an icon.

If no large enough images are found, a checking step 312 is carried out to find one or more other appropriate objects. If there are other appropriate objects, their appropriateness is checked, in the embodiment of FIG. 3 checking step 314 is performed to find out if such an object is large enough. If so, an icon may be generated 316 of the analysed page. In an alternative embodiment, the icon is generated from an object detected as appropriate for the icon. If one or more objects together cover more than a certain percentage of the page area, the page may be considered valid for icon generation. Otherwise step 318 is entered.

It is to be noted that instead of certain portions of a page, the whole page may be considered and selected as an appropriate object in steps 312 and 314. Thus, the overall size determines the validity of the page. In an alternative embodiment, there is a third examination step if in step 512 there are no appropriate objects in the analysed page. The third examination step may check if the whole page may be used for icon formation, and if not, current step 318 may be entered. Further, if none of the pages of the presentation is found valid, then the icon generation module 200 may be configured to select the first page for image generation regardless of its contents.

The icon generation module 200, in the embodiment of FIG. 2 the icon finalization module 204, may in step 310, 316 provide one or more processing steps for the image or other objects from which the icon is formed. One such feature is (up or down-)scaling of the content item portion to correspond to a predetermined icon size. In one embodiment, the icon generation module 200 is configured to: determine essentially empty areas in the selected content item portion, remove the empty areas, and scale down the remaining portion to fit a predetermined size for the icon. This embodiment further enables to prepare the icon such that the visually meaningful areas in the selected portion of the content item can be better identified. Also the shape of the image or the other object may be changed for the icon. For instance, if the icon is chosen to be made out of the largest image of the page, in step 310 a copy of this image is first cropped into the same shape as required for the icon (usually square but may also be of some other format) by leaving out an equal portion from both sides, as illustrated in FIG. 4a. Thus the center of the image is retained, the center usually containing the most important elements of typical images. The resulting image in correct shape may then be scaled down to correspond to the predetermined icon size. It is to be noted that the scaling may be implemented in various ways and there may be more than one applicable icon size. Further, a size range may be determined. Thus, the content item portion should have a size within the range or the icon finalization module 204 scales the content item portion to fit the range. In one embodiment, a user can set the icon size. The icon finalization module 204 may also be configured to support other image or object processing features to be applied to the image, for instance image rotation or colour adaptation.

FIG. 4b illustrates one text object processing example that may be applied in step 316. If the icon is made out of all contents of the page, no cropping is used. Instead, the contents are copied into a single image, which has the same shape as the icon (usually square) and is large enough to cover all the contents. The copied content fills the center of the icon. The unused space around the contents is filled with the background colour used on that particular page. The resulting image is scaled down to be exactly the size of the wanted icon.

As already mentioned, in one embodiment the icon generation process is initiated automatically on the basis of a predetermined trigger, whereby very illustrative icons can be created without further actions from the user.

The above illustrated rules for content item analysing and content item portion selection are some embodiments of the invention and also other rules and algorithms may be applied.

In one embodiment, the content based icon generation is applied in creating icons from content items in SMIL (synchronized multimedia integration language) format. The SMIL is an XML (extensible mark-up language) based format enabling authoring of interactive audiovisual presentations. The SMIL is typically used for multimedia presentations integrating streaming audio and video with images, text or some other media type. For instance, the 3GPP MMS uses a subset of SMIL version 2.0 for media synchronization and scene description. More details on SMIL are available at http://www.w3.org/AudioVideo/ and from W3C specification “Synchronized Multimedia Integration Language (SMIL 2.1)”, 27 Sep. 2005. The above illustrated icon generating features may be applied in an SMIL editor application. Since media objects are referred to in SMIL documents, the icon generation is arranged by applying references to media objects, for instance to image files. However, it is to be noted that the present invention may be applied for generating icons from other media formats.

In one embodiment, the icon comprises multiple parts or images. Such an icon may be generated by applying the above illustrated features such that an appropriate content item portion is selected for each icon part or image. It is feasible to apply different criteria for different icon parts for defining the contents from which a respective icon part is generated. The icon parts or images may be successively displayed. The icon generation module 200 may be arranged to generate an animated icon suggesting the sequence of pages in an associated presentation. This embodiment further enables to better illustrate the contents of a presentation by icons.

Icons may be generated by applying at least some of the above illustrated features for various purposes. One embodiment is a view of a file manager or a specific media gallery, displaying information on folder contents in memory 108. Icons generated by applying the above illustrated features may be applied in various file managament applications, for instance in a file list view. Another examplary application in which the icons may be displayed is a desktop manager displaying a desktop view on a screen of an electronic device 100, such as a PC, a PDA, a laptop computer, or a mobile communications device. In one embodiment, at least some of the above illustrated features related to icon generation are implemented by such applications by which the icons are displayed.

An icon represeting a content item, such as a presentation file, may be presented in a format appropriate for the display 108, current usage context and application. In one embodiment, the icon is displayed as a thumbnail. An icon may be presented with other content item information, such as file name, type, size, location, date, etc.

In one embodiment, besides content item contents, supplementary (metadata) information is used as part of or determines a property of an icon. For instance, supplementary information may be added in step 510, 516 to form a predetermined part of the content based icon. Such supplementary information could include additional content item information, such as those mentioned above. For instance, specific graphics may be used in the icon to illustrate the season when the content item was created. A portion of the space for an icon may be reserved for supplementary information. One further example of such additional information for icon generation is a specific file type thumbnail or another content item property specific information element that is included in or combined with the content based icon. For instance, a specific logo is added to a corner of the icon when the content item comprises audio. It is also feasible to apply specific backround images, frames or templates in icons to provide further information besides content information. An example is that a specific frame is selected for a birthday card or an event invitation.

Even though the invention has been described above with reference to an example according to the accompanying drawings, it is clear that the invention is not restricted thereto but can be modified in several ways within the scope of the appended claims. Different features may thus be omitted, modified or replaced by equivalents.

1-12. (canceled)

13. An electronic device comprising:
memory for storing content items and associated icons,
a display for displaying an icon associated with a content item, and
an icon generation module configured to:
analyze at least some contents of a content item,
select a portion of the content item on the basis of an algorithm, and
specify an icon from the selected content item portion.

14. The electronic device according to claim 1, wherein the icon generation module is further configured to determine if there is a portion of a given media type in the content item and if there is portion of a given media type in the content item, to select a portion comprising data of the given media type for the icon.

15. The electronic device according to claim 2, wherein the icon generation module is further configured to determine if an image exists in the content item and if an image exists in the content item, to select the image for icon specification.

16. The electronic device according to claim 1, wherein the icon generation module is further configured to:
check if there is a portion in the content item meeting a primary criterion,
to check if any other objects meeting a predetermined secondary criterion exist if there is no appropriate content item portion meeting the primary criterion, and
to form the icon from one or more objects meeting the predetermined secondary criterion.

17. The electronic device according to claim 1, wherein the icon generation module is further configured to:
analyze a content item with multiple pages one page at a time such that a second page following a first page is analyzed if, on the basis of analyzing the first page, the contents of the first page do not comprise a portion meeting at least one predetermined selection criterion to be selected for icon creation.

18. The electronic device according to claim 1, wherein the icon generation module is configured to:
determine empty areas in the selected content item portion,
remove the empty areas, and
scale down a remaining portion to fit a given size for the icon.

19. The electronic device according to claim 1, wherein the icon generation module is configured to:
determine a size of an available content item portion, and
select the available content item portion if it is large enough on the basis of a comparison to a given minimum size setting.

20. The electronic device according to claim 1, wherein the electronic device comprises an analyzing module, a content item portion selection module, and an icon finalization module.

21. A method for creating icons for a graphical user interface in an electronic device comprising memory for storing content items and associated icons and a display for displaying an icon associated with a content item, the method comprising:
analyzing at least some contents of a content item,
selecting a portion of the content item on the basis of an algorithm, and
specifying an icon from the selected content item portion.

22. A computer program product stored on a computer readable medium and operable on a processor of an electronic device, the computer program product comprising:
a computer program code portion for analyzing at least some contents of a content item,
a computer program code portion for selecting a portion of the content item on the basis of an algorithm, and
a computer program code portion for specifying an icon from the selected content item portion.

23. A computer program product according to claim 10, wherein the computer program product configures the electronic device to determine if there is a portion of a given media type in the content item and to select for the icon a portion comprising data of the given media type.

24. An arrangement for creating icons for a graphical user interface, wherein the arrangement comprises:
means for analyzing at least some contents of a content item,
means for selecting a portion of the content item on the basis of an algorithm, and
means for specifying an icon from the selected content item portion.
